(19) United States
(12) Patent Application Publication
(10) Pub. No.: US 2012/0216047 A1
(43) Pub. Date: Aug. 23, 2012

(54) DIGITAL KEY FEATURING ENCRYPTION AND WEB GUIDE

(75) Inventors: Hong-Chi YU, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/272,420

(22) Filed: Oct. 13, 2011

(30) Foreign Application Priority Data
Feb. 18, 2011 (TW) 100105472

(51) Int. Cl. G06F 21/00

(52) U.S. Cl. 713/185

(57) ABSTRACT

The present invention targets at providing a digital key featuring encryption and web guide. When users electrically connect the digital key to a computer, the computer can automatically execute to activate a browser program and automatically key in (simultaneously read) a specific web address and specific log-on data without users' operation so as to prevent the attack tricks of unscrupulous persons from stealing information at user end and secure digital information security at user end. Additionally, users don't need to memorize specific log-on data and won't forget or lose log-on information, thereby rendering sufficient convenience.

### FIELD OF THE INVENTION

The present invention relates to a digital key, and more particularly to a digital key enabling a computer to automatically activate a browser program and automatically enter a specific website address and log-on information without requiring users' operation when the digital key is electrically connected to the computer.

### BACKGROUND OF THE INVENTION

With the advent of the networking era information sharing speed accelerates and information technology is widespread and progressive on daily basis. Computers, communications and consumer electronics, the so-called 3C, go deep into people's life all over the place.

In everyday life individuals, families, corporate and government organizations extensively utilize all sorts of electronic devices, such as computers, mobile phones and the like, to process basic daily needs, such as food, clothing, housing and transportation, education or entertainment.

The most common examples are platforms for promoting and selling (virtual) merchandise or service, such as the platforms for opening personal websites, creating blog to communicate with others or demonstrate personal profile through network or performing e-shopping. Websites for Internet banking, on-line game and transaction of virtual currency/points are emerging network platforms. Alternatively, electronic certificate service systems of government organizations allow people to handle government related affairs, such as paying income tax, maintaining personal particulars, paying related charge, or accessing seniority details, through a network.

As the course of information exchange or transaction usually deals with exchange of money, benefit or personal confidential information such as account number and password, valuable information like this may become a target on which unscrupulous persons cast their greedy eyes. Generally speaking, those unscrupulous persons oftentimes employ screen logger, trojan horse implantation and direct attack on computer to steal other persons' valuable information using different tricks, such as connection with phishing site or malicious software, for sales or illegal use.

Although information security maintenance works always endeavor to prevent critical data at user end from being stolen during a data transmission process through a network, the proposed protection means only targets at protecting particular attack approach instead of a full range of protection against all sorts of malicious attacks from the unscrupulous persons. Given electronic fund transfer as an example, an approach using virtual keyboard to randomly switch the key positions thereof is employed to prevent unscrupulous persons from stealing data at the user end using keylogger software. However, such approach can only avoid specific attach patterns. Once the unscrupulous persons change the attach means to a screen logger, for instance, to replace the keylogger software, confidential information at user end can still be easily accessed, rendering the original means vulnerable.

Accordingly, a good protection approach needs to be provided at user end to effectively prevent unscrupulous person from stealing data information so as to keep digital information secure at user end.

### SUMMARY OF THE INVENTION

In view of the foregoing problem, the present invention targets at providing a digital key featuring encryption and web guide allowing a computer to automatically execute to activate a browser program and automatically key in (simultaneously read) a specific web address and specific log-on information without users' operation when the digital key is electrically connected to the computer.

As such, a first objective of the present invention is to provide a digital key featuring encryption and web guide ensuring to protect digital data at user end against attack tricks of unscrupulous persons intending to steal digital information at user end.

A second objective of the present invention is to provide a digital key featuring encryption and web guide for users not to spend effort in memorizing specific log-on data such as user ID and password, thereby getting rid of the concern of forgotten or lost log-on data.

To achieve the first objective, the digital key featuring encryption and web guide is electrically connected to a computer and has a USB communication interface unit, a memory unit and a control unit.

The USB communication interface unit is adapted to electrically connect with a socket of the computer.

The memory unit is provided to read or write digital data and has a web address and specific log-on data.

The control unit is electrically connected between the memory unit and the USB communication interface unit for executing commands and controlling to input and output data and has an HID (human interface device) module and an automatic key-in module.

When the USB communication interface unit is electrically connected with the socket of the computer, the control unit sends an HID connection request to the computer. The automatic key-in module is then used to activate a default browser program and sequentially key in the web address stored in the memory unit. After a web page corresponding to the web address is opened, the specific log-on data are keyed in a hidden column of the web page.

Preferably, the specific log-on data are generated by a compiler program and has a user ID and a password.

To achieve the second objective, the digital key featuring encryption and web guide is electrically connected to a computer and has a USB communication interface unit, a memory unit and a control unit.

The USB communication interface unit is adapted to electrically connect with a socket of the computer.

The memory unit is provided to read or write digital data and has a web address, specific log-on data and an executable program.

The executable program is executed to call a default browser and simultaneously read the web address and the specific log-on data.

The control unit is electrically connected between the memory unit and the USB communication interface unit for executing commands and controlling to input and output data.

When the USB communication interface unit is electrically connected the socket of the computer, a virtual device module of the control unit sends a virtual device connection request to the computer so that the computer automatically executes the executable program. The executable program has a step of activating a default browser program and simultaneously reading the web address and the specific log-on data.

Preferably, the specific log-on data are generated by a compiler program and have a user ID and a password.

Preferably, the virtual device module is one of a CD player, a hard drive and a floppy drive.

In contrast to conventional technique, when the digital key of the present invention is electrically connected to a computer, the computer can automatically execute to browser program and automatically key in (simultaneously read) a specific web address and specific log-on data without users' operation. Attack tricks of unscrupulous person intending to steal digital information at user end can be prevented to ensure digital data security at users end. Furthermore, users won't need to spend effort in memorizing specific log-on data, rendering sufficient convenience.

The foregoing and other features and advantages of the present invention will be more clearly understood through the following descriptions with reference to the drawing, wherein:

### BRIEF DESCRIPTION OF THE DRAWINGS

FIG. 1 is a functional block diagram of a first embodiment of a digital key featuring encryption and web guide in accordance with the present invention; and

FIG. 2 is a functional block diagram of a second embodiment of a digital key featuring encryption and web guide in accordance with the present invention.

### DETAILED DESCRIPTION OF THE PREFERRED EMBODIMENT

It is to be noted that the following descriptions of preferred embodiments of this invention are presented herein for purpose of illustration and description only; it is not intended to be exhaustive or to be limited to the precise form disclosed.

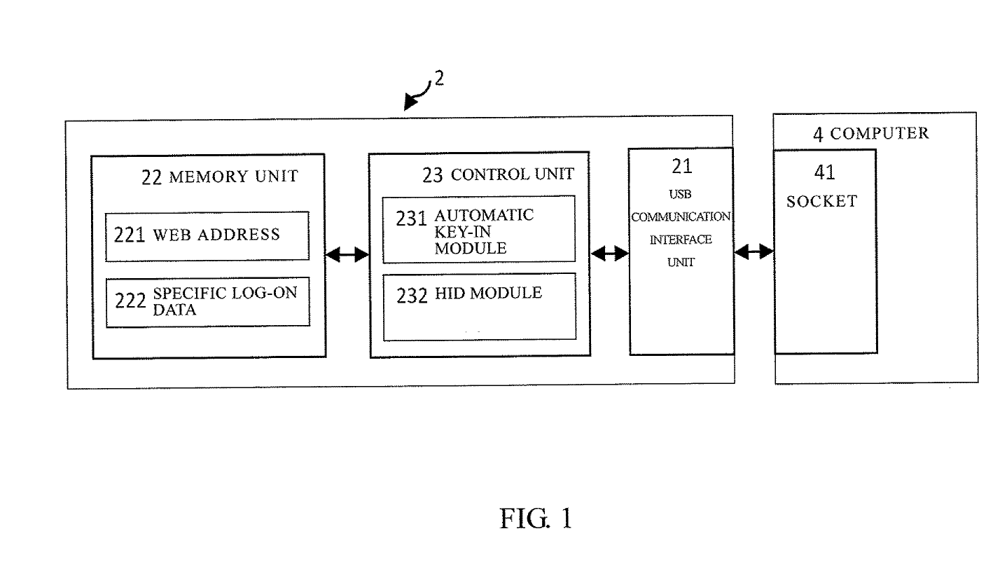

With reference to FIG. 1, a first embodiment of a digital key featuring encryption and web guide 2 in accordance with the present invention is electrically connected to a computer 4 and has a USB communication interface unit 21, a memory unit 22 and a control unit 23.

The USB communication interface unit 21 is electrically connected with a socket 41 of the computer 4. The memory unit 22 is provided to read/write digital data. The control unit 23 is electrically connected between the memory unit 22 and the USB communication interface unit 21 for executing commands and controlling to input and output data.

The memory unit 22 has a web address 221 and specific log-on data 222. The control unit 23 has an MMI (man machine interface) device module and an automatic key-in module 231. Specifically, the MMI is the space where interaction between humans and machines occurs. The goal of interaction between a human and a machine at the user interface is effective operation and control of the machine, and feedback from the machine which aids the operator in making operational decisions. In our invention, the MMI is Preferably an HID (human interface device) a type of computer device that interacts directly with, and most often takes input from, humans and may deliver output to humans most commonly refers to the USB-HID specification. Preferably, the MMI device module is an HID module 232.

When the USB communication interface unit 21 is electrically, connected with the socket 41 of the computer 4, the HID module 232 of the control unit 23 sends an HID connection request to the computer 4. In the present embodiment, the HID module 232 is a virtual keyboard. The automatic key-in module 231 is then used to activate a default browser program and sequentially key in the web address 221 stored in the memory unit 22. After a web page corresponding to the web address 221 is opened, the specific log-on data 222 are keyed in a hidden column of the web page.

Specifically, the specific log-on data 222 may have a user ID and a password. When being keyed in, the specific log-on data are inputted in a hidden state, thereby keeping the specific log-on data confidential and not easily stolen.

Preferably, the specific log-on data 222 are generated by a complier program, and the specific log-on data 222 have a user ID and a password for logging on a web page corresponding to the web address.

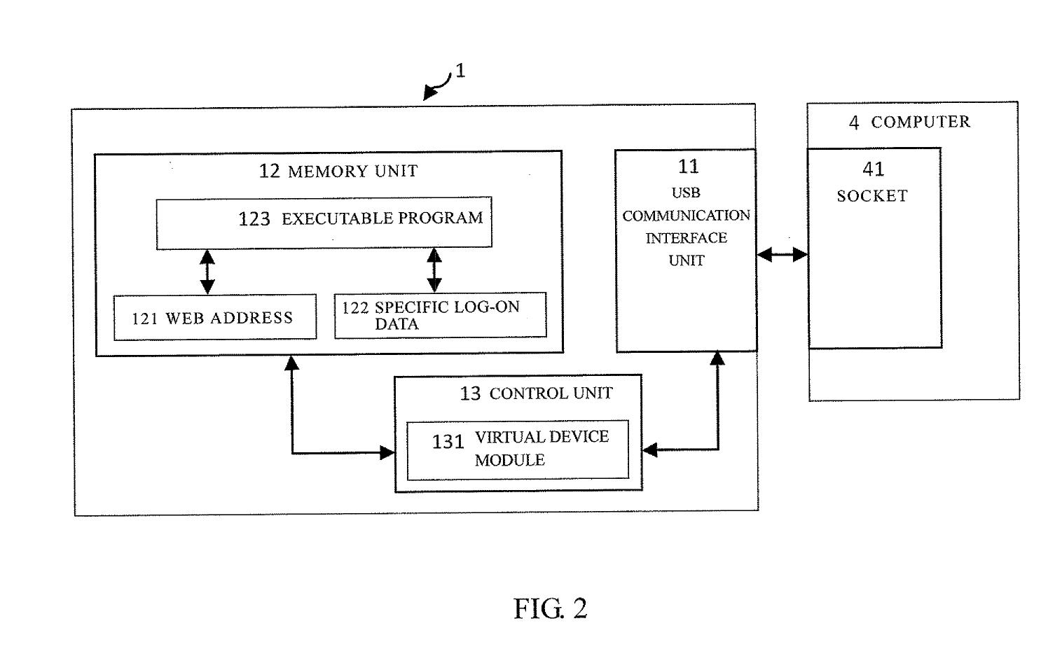

With reference to FIG. 2, a second embodiment of a digital key featuring encryption and web guide 1 in accordance with the present invention is electrically connected to a computer 4 and has a USB communication interface unit 11, a memory unit 12 and a control unit 13.

The USB communication interface unit 11 is electrically connected with a socket 41 of the computer 4. The memory unit 12 is provided to read/write digital data. The control unit 13 is electrically connected between the memory unit 12 and the USB communication interface unit 11 for executing commands and controlling to input and output data.

The memory unit 12 has a web address 121, specific log-on data 122 and an executable file/program 123. The executable file/program 123 is executed to call a default browser and simultaneously read the web address 121 and the specific log-on data 133. The control unit 13 has a virtual device module 131.

Therefore, when the USB communication interface unit 11 is electrically connected the socket 41 of the computer, the virtual device module 131 of the control unit 13 sends a virtual device connection request to the computer 4. The virtual device module 131 may be any one of a CD player, a hard drive and a floppy drive. In the present embodiment, the virtual device module 131 is a virtual CD player. The computer 4 then automatically executes the executable file/program 123.

Moreover, the executable file/program 123 may have an execution step of activating a default browser program and simultaneously reading the web address 121 and the specific log-on data 122. Hence, by calling the browser program and simultaneously reading the web addresses 121 and the specific log-on data 122, the executable file/program 123 can prevent unscrupulous persons from stealing users' specific log-on data 122 at user end with trojan horse or hacker software.

Preferably, the specific log-on data 122 are generated by a compiler program, and have a user ID and a password for logging on a web page corresponding to the web address.

Preferably, the executable file/program 123 executes an encryption step to prevent unscrupulous persons from stealing the specific log-on data 122 of users at user end when acquiring the specific log-on data 122.

In accordance with the first and second embodiments of the present invention, the present invention targets at providing a digital key featuring encryption and web guide. When a user starts a computer, the computer can automatically execute a browser program and automatically key in (simultaneously read) the specific web address and the specific log-on data without going through users' operation.

As the present invention no longer needs to manually inputting any information through users to automatically log on specific web page, different information stealing tricks, such as screen logger, trojan horse implantation, direct attack on computer, and connection with phishing site or malicious software, can be effectively avoided. Accordingly, the present invention can surely prevent the attack means of unscrupulous persons for stealing information at user end and ensure that users won't forget or lose their log-on information.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A digital key featuring encryption and web guide electrically connected to a computer and comprising:
a USB communication interface unit adapted to electrically connect with a socket of the computer;
a memory unit provided to read or write digital data and having a web address and specific log-on data; and
a control unit electrically connected between the memory unit and the USB communication interface unit for executing commands and controlling to input and output data and having an HID (human interface device) module and an automatic key-in module;
wherein when the USB communication interface unit is electrically connected with the socket of the computer, the control unit sends an HID connection request to the computer, the automatic key-in module is then used to activate a default browser program and sequentially key in the web address stored in the memory unit, after a web page corresponding to the web address is opened, the specific log-on data is keyed in a hidden column of the web page.

2. The digital key as claimed in claim 1, wherein the specific log-on data are generated by a compiler program and have a user ID and a password.

3. A digital key featuring encryption and web guide electrically connected to a computer and comprising:
a USB communication interface unit adapted to electrically connect with a socket of the computer;
a memory unit provided to read or write digital data and having:
a web address;
specific log-on data; and
an executable program executed to simultaneously call a default browser and read the web address and the specific log-on data;
a control unit electrically connected between the memory unit and the USB communication interface unit for executing commands and controlling to input and output data;
wherein when the USB communication interface unit is electrically connected the socket of the computer, a virtual device module of the control unit sends a virtual device connection request to the computer so that the computer automatically executes the executable program, the executable program has a step of activating a default browser program and simultaneously reading the web address and the specific log-on data.

4. The digital key as claimed in claim 3, wherein the specific log-on data are generated by a compiler program and have a user ID and a password.

5. The digital key as claimed in claim 3, wherein the virtual device module is one of a CD player, a hard drive and a floppy drive.
